(19) United States
(12) Patent Application Publication
(10) Pub. No.: US 2007/0064921 A1
(43) Pub. Date: Mar. 22, 2007

(54) Caller-Generated ring tones

(75) Inventors: Larry Albukerk, San Francisco, CA (US); Stefan Scheinert, San Diego, CA (US)

Correspondence Address: HOGAN & HARTSON L.L.P., 1999 AVENUE OF THE STARS, SUITE 1400, LOS ANGELES, CA, 90067, US

(73) Assignee: Realtime Ringtones, LLC

(21) Appl. No.: 11/226,997

(22) Filed: Sep. 14, 2005

(51) Int. Cl. H04M 1/00; H04M 3/00

(52) U.S. Cl. 379/373.02; 379/374.01; 379/374.03

(57) ABSTRACT

A called device plays a ring tone provided by a calling device to signal an incoming call from the calling device. A ring tone recorder may provide the caller generated ring tone from the calling device to the called device. The ring tone recorder records a ring tone for the calling device, and then provides the recorded ring tone to a called device to signal an incoming call from the calling device.

### FIELD OF THE INVENTION

The present invention relates to ring tones and, in particular, relates to caller-generated ring tones.

### BACKGROUND OF THE INVENTION

In conventional communication networks, a phone rings when it is being called to alert the user of the phone to the incoming call. Until recently, rings have been simple sounds or tones that are preprogrammed into the phone. Recent improvements in phone technology and networks have enabled customization of ring tones, such as by user selection from a library of pre-stored ring tones in the phone, or by download of ring tones from a remote server. Moreover, since recent phones have substantial audio and visual output capability, ring “tones” may actually include music, voice, pictures and video.

Phones may also be programmed so that ring tone is dependent on the identity of the caller. Thus, the ring tone that is played is based on a fixed relation between the caller's identity and the particular ring tone. Present communication networks are limited in that this relation must be selected and fixed by the user prior to any calls. In addition, the calling party has no capability of changing this relation. The ring tones are fixed and known devices and networks do not allow instantaneous changes or use of information from the calling party other than the association of an incoming phone numbers with a pre-stored ring tone.

### SUMMARY OF THE INVENTION

The present invention addresses the limitations mentioned above and allows the caller to control what the receiver hears or sees as the ring tone.

One embodiment of the invention is a communication system comprising a called device and a calling device, wherein the called device plays a ring tone provided by the calling device to signal an incoming call from the calling device.

Another embodiment of the invention is a ring tone recorder for providing caller generated ring tones from a calling device to a called device. The ring tone recorder records a ring tone for the calling device, and then provides the recorded ring tone to a called device to signal an incoming call from the calling device.

Another embodiment of the invention is a method for using a caller-generated ring tone to signal an incoming call. A message is received containing a caller-generated ring tone, and the caller-generated ring tone is played for an incoming call.

These and other embodiments of the invention are described in more detail in the following description, drawings and claims.

### BRIEF DESCRIPTION OF THE DRAWINGS

FIG. 1 is a diagram of a conventional communications network.

FIG. 2 is a diagram of a communication network according to the present invention with a ring tone recorder.

### DETAILED DESCRIPTION OF THE INVENTION

“Ring tone” as used herein is broadly defined as any audio, text or visual alert that provides a notification that a phone is being called. Thus, a ring tone may an include an audio clip, such as a voice recording, music, text, pictures, video clips, or any combination of these or other audio and visual alerts. Ring tones are generated and downloaded or streamed to the device being called prior to or during a call.

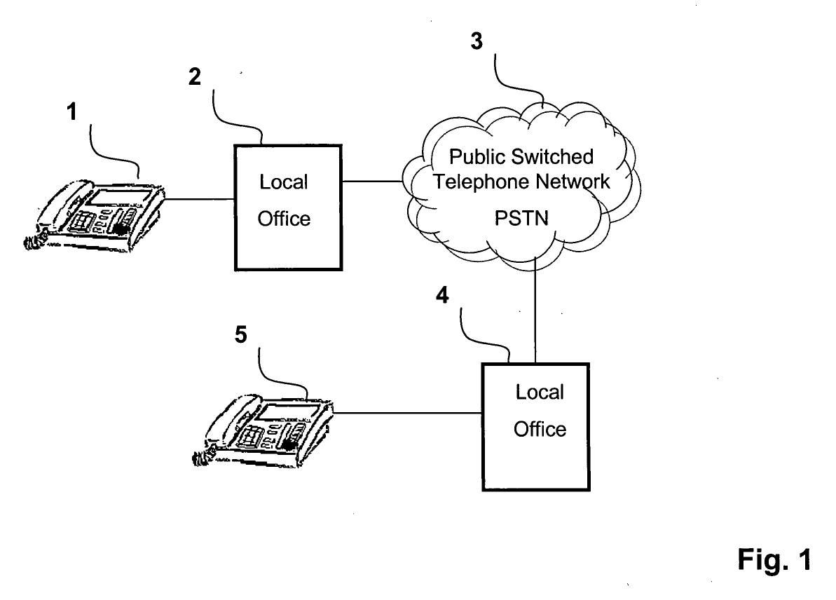

FIG. 1 is a diagram of a conventional communication network. A call from a phone 1 is routed through a local office 2 and the Public Switched Telephone Network (PSTN) 3 to a local office 4 of a called phone 5. Local office 4 sends a signal to phone 5, and phone 5 receives the signal and plays a preprogrammed ring tone to provide a notification of the incoming call.

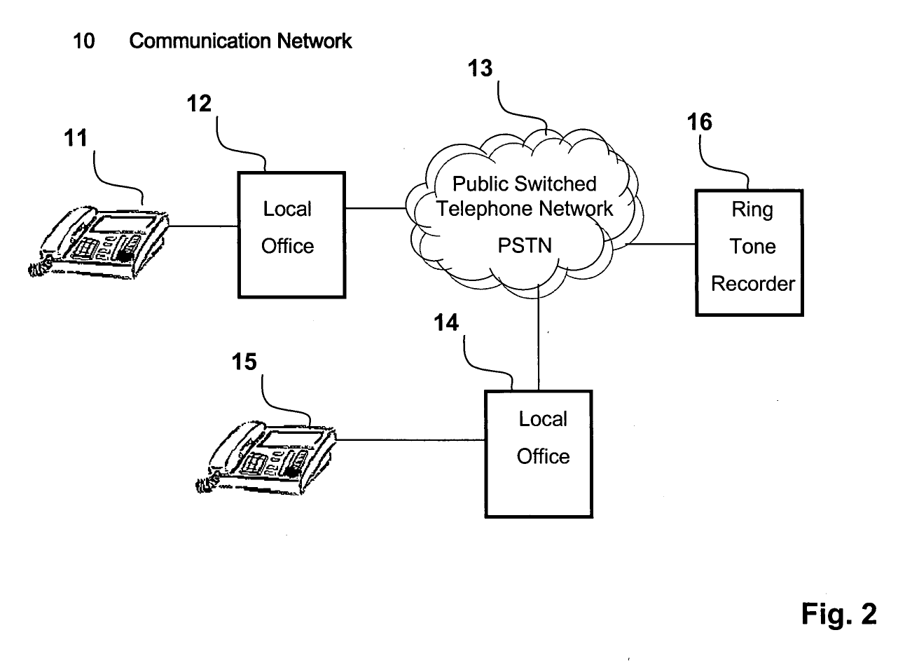

FIG. 2 shows a communications network 10 according to the present invention. According to the present invention, a caller 11 is able to select a desired ring tone and cause the device being called to play that ring tone. The caller calls a first number of a ring tone recorder 16 to record the desired ring tone, and then calls (separately or within the same call) the number of the called device 15. These calls are routed through the caller's local office 12, PSTN 13 and the called device's local office 14. In one embodiment, ring tone recorder is incorporated in or a part of the local office. It should be noted that local offices 12, 14 may comprise a conventional local office for conventional landline phones, or may alternatively comprise a mobile switching center (MSC) for mobile, wireless phones, or a softswitch for VoIP phones. The term “local office” is intended to encompass all of these alternatives.

In one embodiment of the invention, the call set up procedure is changed. The ringing message (e.g. INVITE, the call set up message in the SIP protocol) is changed to include information about the recorded ring tone, or may itself be a part of the ring tone. Called device 15 uses this information about the recorded ring tone instead of a conventional preprogrammed ring tone. Local offices 12, 14 cause the recorded ring tone information to be carried through network 10 to called device 15. For example, in a VoIP network, where the SIP protocol is typically used, the INVITE or MESSAGE messages could be used to transmit the ring tone information.

Alternatively, the local office may send a data message to called device 15 which contains the prerecorded ring tone, which called device 15 then uses for an incoming call. In the SIP protocol, the MESSAGE message may be used to download the ring tone to the called device. In mobile systems, SMS, MMS or other packet data messages could be used to download the ring tone.

Once downloaded to the called device, the recorded ring tone may be played for the very next incoming call. Alternatively, the data message may include a reference number linking an incoming phone number with the recorded ring tone. The ring tone is then played when a call from the associated incoming phone number is received. This prevents the caller recorded ring tone from being played for another caller if an intervening phone from that other caller is received before the call of the recorded ring tone caller is received.

Called device 15 is a communication device that can accept software downloads and has a controllable ringer function. Called device 15 stores the data message (which, as described above, is either a part of the call set up message or is a separate data message) and plays the prerecorded ring tone in that message just for the associated incoming call, and not for incoming calls from other numbers. Called device 15 may store the ring tone for future use, even in connection with calls from other numbers if desired.

In another embodiment, the calling device 11 uploads a ring tone to the called device 15 on a permanent basis. Thus, the set up for the prerecorded ring tone (obtained from ring tone recorder 16 and provided to called device 15 as described above) is done only once, and then each time device 11 calls device 15 the recorded ring tone is activated.

As noted above, calling device 11 first calls a service number of ring tone recorder 16 to select and record the desired ring tone. Once recording is finished, the number of called device 15 is entered. Alternatively, it may have already been entered such as with a prefix (e.g. #44#12345678 whereas #44# indicates the access to ring tone server 16 and 12345678 is the number of device 15).

Ring tone recorder 16 may record the voice of the caller as a voice clip to be used as the recorded ring tone sent to called device 15. Alternatively, the caller may select other ring tones stored on server 16, such as music, other audio sequences, pictures, video clips or combinations thereof, or even real-time information such as news (audio and video clips), announcements, pictures (such as from online photo albums, etc.).

In another embodiment, the ring tone is composed by entering and sending data (e.g. over the Internet) to ring tone recorder 16, which generates a ring tone by using the data along with standard and customized audio and video clips. For example a caller may enter his name (“Bob”), the named of the called party (“Chris”), and data defining an environment (e.g. “casual”). Ring tone recorder 16 then generates the complete ring tone, e.g., “Hi Chris, this is Bob, pick up the phone”.

Called device 15 may be configured to accept (or not accept) caller generated ring tones. Called device 15 may decide whether to accept caller generated ring tones based on factors such as time, location, incoming phone number or other relevant factors. Acceptance of caller generated ring tones may also be manually turned on and off. Alternatively, an environment feature may be set to “private” to allow play of caller generated ring tones, or to “official” to play only internally stored ring tones for all incoming calls.

In addition, called device 15 may classify all incoming caller generated ring tones, and decide whether to play them based on the classification. For example, an incoming caller generated ring tone of “Hey buddy” would probably be classified as “private”. If called device is set to “private”, the caller generated ring tone is played, whereas if it is set to “official”, the internally stored and set ring tone of called device 15 is played. Ring tones may also be screened based on voice or text recognition. Called device may screen and not play caller generated ring tones containing curse words, for example.

A caller generated ring tone may also be classified on the basis of other information with the incoming call, rather than the content of the ring tone itself. For example, the incoming number itself may be used to classify the ring tone, i.e., all calls from friend Bob may be classified as private. Thus, caller generated ring tones from Bob's number are played only when the phone is set to “private”, regardless of the actual content of the ring tone.

A tone or beep may be generated and played first by called device 15 before the recorded ring tone is played, so the user can pay attention to the recorded ring tone received from the calling device 11.

A caller generated ring tone may be saved as a voice mail. Thus, caller generated ring tones that are not accepted or for which the recipient is not available to accept the call may still be heard in voice mail.

In another embodiment, ring tone recorder 16 is not necessary. A called device 15 generates no ring tone but goes immediately to a special “connected” mode, where incoming audio (from calling device 11) is sent to the loudspeaker and the outgoing audio signal (from called device 15) is muted until the user of phone 15 answers the call. The user of calling device 11 may hear a ringing tone during this time until the called party picks up the phone. Thus, the caller may speak a “ring tone” in real time, which is directly transmitted to and played on the loudspeaker of called device 15, with no prerecording necessary. Alternatively, calling device 11 may directly transmit a selected ring tone stored in calling device 11 (rather than obtained from ring tone recorder 16) to called device 15.

In another embodiment, a caller to the number of called device 15 is given the option to use a ‘personalized ring tone’ (e.g. ‘hello’) or to complete the call without a personalized ring tone. The caller, even though he calls the number of the called device (e.g. the caller calls 123-4567), is not connected directly to 123-4567, but instead is first connected to ring tone recorder 16, which records the ring tone and forwards it to called device 15 for play. As soon as the caller picks up the phone the call is connected and the ring tone is off. This configuration provides called device 15 with the ability to control the environment and ring tones, whereas the previous embodiments are driven primarily by the calling party.

Other embodiments and implementations of the invention will be or will become apparent to one of ordinary skill in the art. All such additional embodiments and implementations are within the scope of the invention as defined by the accompanying claims.

1. A communication system comprising a called device and a calling device, wherein the called device plays a ring tone designated by the calling device to signal an incoming call from the calling device.

2. A communication system as claimed in claim 1, wherein the ring tone is music, voice, pictures, video or a combination thereof.

3. A communication system as claimed in claim 1, wherein the ring tone is pre-recorded information from a user of the calling device.

4. A communication system as claimed in claim 1, wherein the ring tone is pre-selected information from a user of the calling device.

5. A communication system as claimed in claim 1, and further comprising a ring tone recorder, wherein the calling device first calls the ring tone recorder, which records the ring tone that is provided to the called device.

6. A communication system as claimed in claim 1, wherein the ring tone is downloaded to the called device as part of the call set up message.

7. A communication system as claimed in claim 1, wherein the ring tone is downloaded to the called device as part of a separate data message.

8. A ring tone recorder for providing ring tones designated by a calling device to a called device, wherein the ring tone recorder records or stores a ring tone for the calling device, and then provides the recorded or stored ring tone to the called device to signal an incoming call from the calling device.

9. A ring tone recorder as claimed in claim 8, wherein the ring tone recorder is a part of the local office.

10. A ring tone recorder as claimed in claim 8, wherein the ring tone recorder can be accessed by the Internet.

11. A method for using a caller-generated ring tone to signal an incoming call comprising:
receiving a message containing a caller-generated ring tone; and
playing the caller-generated ring tone for the incoming call.

12. A method as claimed in claim 11, wherein the caller-generated ring tone is played for a next incoming call.

13. A method as claimed in claim 11, wherein the message contains a telephone number associated with the caller-generated ring tone, and wherein the caller generated ring tone is played when a call is received from the associated telephone number.

14. A method as claimed in claim 11, wherein the message is part of a call set up procedure between a calling device and a called device.

15. A method as claimed in claim 11, wherein the caller-generated ring tone is received from a ring tone recorder.

16. A method as claimed in claim 11, and further comprising:
classifying the caller-generated ring tone and deciding whether to play the ring tone based on that classification.

17. A method as claimed in claim 11, and further comprising:
deciding whether to play the caller-generated ring tone based on other information contained in the message.

18. A method as claimed in claim 11, and further comprising storing the caller-generated ring tone in voice mail.

19. A method as claimed in claim 11, and further comprising storing the caller-generated ring tone and playing it for all future incoming calls from the associated telephone number.
